(19) United States
(12) Patent Application Publication
(10) Pub. No.: US 2014/0222517 A1
(43) Pub. Date: Aug. 7, 2014

(54) APPARATUS, SYSTEM AND METHOD FOR RETAL-TIME PRICING ON CONSUMABLE ITEMS IN REATIL EMBODIMENTS

(71) Applicant: BIZEQUITY LLC, WAYNE, PA (US)

(72) Inventor: Michael M. Carter, Wayne, PA (US)

(21) Appl. No.: 14/175,684

(22) Filed: Feb. 7, 2014

Related U.S. Application Data
(60) Provisional application No. 61/762,060, filed on Feb. 7, 2013.

(51) Int. Cl. G06Q 30/02; G06Q 50/12

(52) U.S. Cl. CPC G06Q 30/0206; G06Q 50/12
USPC 705/7.35

(57) ABSTRACT

The present invention provides a dynamic computing system, comprising a non-transitory computer readable storage medium having encoded thereon computer executable instructions for providing pricing information to a requester via a presentation layer, a valuation engine comprised of computing code capable of executing rules that generate at least one value for at least one food item responsive to at least the supply information and customer information accessed from at least one network, and a data layer capable of receiving at least the supply information and the customer information, and communicatively connected to said valuation engine, and further comprising food offering information for the requester for presentation to the requester via said presentation layer, wherein the food offering information comprises at least one offer price for the at least one food item.

### CROSS-REFERENCE TO RELATED APPLICATIONS

This application claims priority to U.S. Provisional Patent Application Ser. No. 61/762,060, filed Feb. 7, 2014, entitled Apparatus, System and Method for Real-Time Pricing of Consumable Items in Retail Embodiments, the whole of which is incorporated herein by reference as if set forth in its entirety.

### BACKGROUND

1. Field of the Disclosure

The field of the invention is consumable services, and particularly menu pricing at dining and/or drinking establishments.

2. Background of the Disclosure

Restaurants, bars, and other consumer establishments where food and/or drink is prepared and served to patrons generally have pre-printed menus showing fixed prices. In some instances, the pre-printed menus are used for months or years before any changes are made to the menu or pricing of the menu items. In other instances, the menus are printed on a daily basis, often to reflect daily menu changes. However, even in such instances where the menu is printed daily, the pricing of the items on the menu remains static. Some consumer establishments place items on the menu, such as the seafood catch of the day or seasonal items, which are listed for sale at the going “market price”. However, during any given day of operation, “market prices” are likely to be viewed as static. Moreover, the only way for the patron to find out the current market prices is to ask the wait staff.

### SUMMARY OF THE INVENTION

The present invention is directed to methods and systems for pricing menu items at a consumer establishment. Data is repeatedly or continuously received via a tracking system, wherein the data relates to at least one of menu items and patron orders for menu items at the consumer establishment. The data may be across one or multiple establishments, wherein such multiple establishments may or may not be co-owned or co-controlled, and may be tied to item supply (for a certain time-frame, such as for the preceding 2 hours), item demand (for a certain time-frame, such as for the preceding 2 hours), or both. The received data may repeatedly analyzed, and the analyzed data is used to set current prices for the menu items, or accept bids for the menu items. The current prices may be displayed to a patron, such as via an in-store display, such as a ticker above a bar, and an order is received from the patron for one or more of the menu items may then be based upon the current prices.

Accordingly, an improved method for pricing menu items at a consumer establishment is disclosed. Advantages of the improvements will appear from the drawings and the description of the preferred embodiment.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates aspects of the disclosed embodiments;

FIG. 2 illustrates aspects of the disclosed embodiments; and

FIG. 3 illustrates aspects of the disclosed embodiments.

### DETAILED DESCRIPTION OF THE EMBODIMENTS

It is to be understood that the figures and descriptions of the present invention have been simplified to illustrate elements that are relevant for a clear understanding of the present invention, while eliminating, for the purpose of clarity, many other elements found in typical food service environments, electronic purchase, telecommunications network, and related apparatuses, systems, and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to the disclosed elements and methods known to those skilled in the art.

Turning in detail the drawings, the illustrated are exemplary systems and methods for pricing menu items at a consumer establishment, such as a restaurant or bar. “Menu items”, as used herein, may include any prepared or pre-packaged food item that may be provided to the patron at the consumer establishment, or any pre-packaged, prepared or mixed drink, including alcoholic drinks, which may be provided to the patron at the consumer establishment.

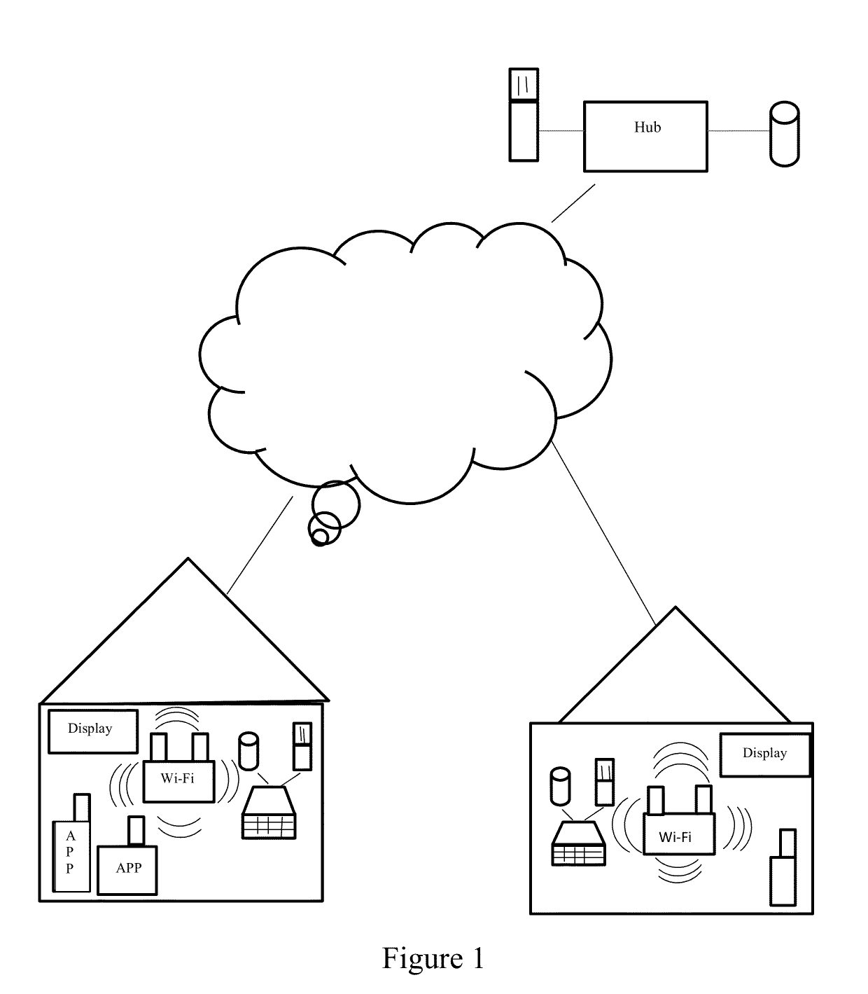

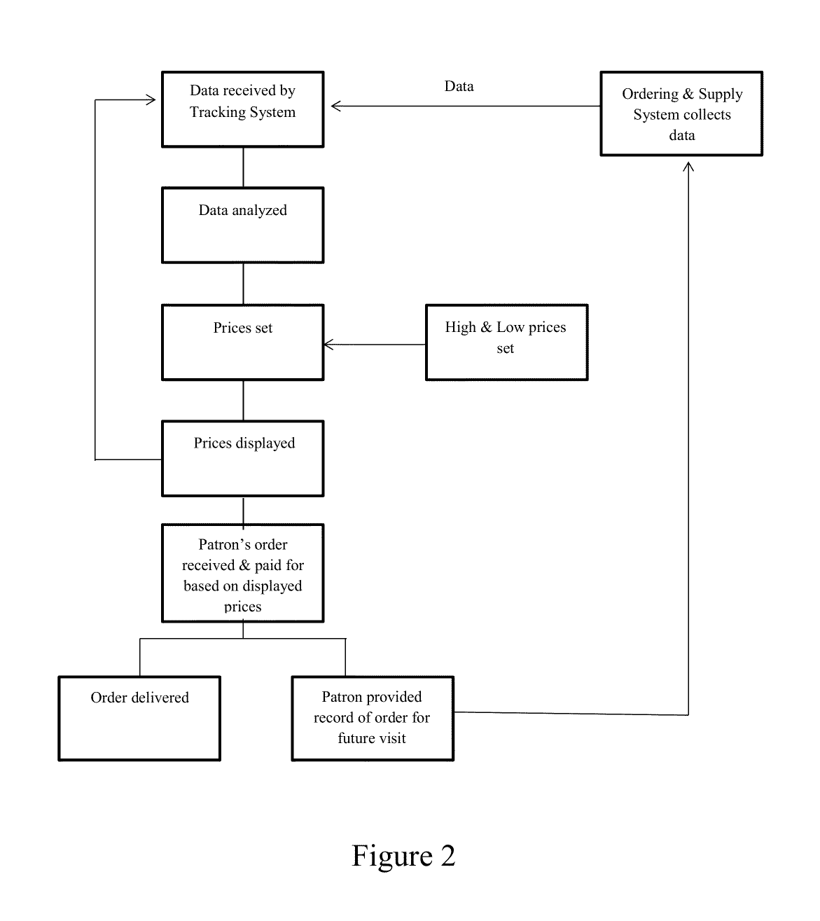

As illustrated in FIGS. 1 and 2, the data used by the tracking system is collected by an ordering and supply system of the type that is commonly used in both restaurants and bars for tracking consumables and patrons' orders. The ordering and supply system may be of any type known to those skilled in the art. Such tracking systems generally track all orders placed for menu items, and all supplies, including the primary ingredients for culinary preparations, pre-made food items, ingredients for mixed beverages, pre-made beverages (cola, beer, etc.) and the like. Of course, the beverages may be alcoholic and/or non-alcoholic, depending upon the menu choices made by the consumer establishment. Further, this tracking system may be interrelated as to multiple co-owned or co-controlled establishments, and may provide a data flow to a central data hub, wherein the data flow may allow for accumulation of data relating to multiple establishments that are no co-owned or co-controlled.

Further, the data may be relational in the tracking system, and as such may include indications of supply, inventory, demand, pricing, etc., by name of establishment, geographic location of establishment, ratings of the establishment (such as ratings by Zagat's, Yelp, or the like), price tier of the establishment, or the like. Certain of this information may be tracked from the establishment itself, and other of this information may be obtained via publicly available sources, such as Internet links, databases, or the like.

The tracking system may also include an ordering and supply system that may be fully integrated with each other into a single, monolithic system. In such embodiments, particularly wherein the data tracking is performed at a central hub, such an ordering and supply system may reflect a “mirrored” data tracking that occurs at local to the establishment, or may reflect a secure partitioning of the remote data tracking at the central hub, wherein an establishment has secure access only to its partition, and/or to the partitioning of establishments that are co-owned and/or co-controlled with that establishment. Thereby, locally generated data, which may include data from an ordering and supply system, may be received by the tracking system, whereat it may analyzed.

The method of transferring the data may take almost any known form for transferring data between the two systems, such as: a wired or wireless network; a cellular, Intranet, or Internet network; or even via a portable data storage device such as an optical disk or a nonvolatile random access memory token. However, if data is transferred using a method that does not permit on-demand communications between the two systems, real time menu pricing will be unavailable. In such cases, the pricing will have an inherent delay as compared to the time of data collection by the ordering and supply system.

The disclosed data may be obtained, transferred, and stored at the direction of one or more computer processors. The disclosed data may be non-transitorily stored, analyzed, and processed, as directed by the one or more processors, to and from one or more databases that may reside at one or more computing memory locations. Such locations may include the central hub, which may comprise one or more servers.

Once the data is received by the tracking system, that data may be analyzed. Menu prices may be set and/or modified based upon the data analysis. The data analysis may be any appropriate or desired form of analysis, including anything from complex statistical analyses, such as may be based on the price tier of a restaurant, reviews of the restaurant, competitors to the restaurant, or the like, to a simplified analysis which looks for predetermined thresholds within the supply and demand data.

Similarly, data analysis may allow for bidding on food and drink to occur. For example, in a bidding or real-time pricing context, the aforementioned data analysis may indicate minimum threshold pricing for food and/or drink, such as to maintain profitability, increase foot traffic as compared to competitors, as may be indicated by available supply, local geographic demand, or any like factors as will be evident to those skilled in the art in light of the discussion herein.

In setting the prices for the menu items, the tracking system may again use any number of known or desired methods for setting prices. Pricing limits may be based upon the needs of the consumer establishment. For example, the operator of the consumer establishment may wish to individually set absolute high and low prices for some or all of the various menu items, thereby placing limits on the pricing capabilities of the tracking system. By setting the high and low prices for different menu items, the operator can ensure that menu item prices do not sink below the cost of supplies, and on the flipside, the menu item prices do not increase so drastically as to offend consumer sensibility.

In addition to analyzing the supply and order data and setting prices, the tracking system may also track the pricing history for the various menu items. Other history data which may be tracked includes the different menu items that are ordered and the price associated with each individual order, the numbers of previously ordered menu items which have been and have yet to be delivered, the cost of supplies used to prepare the various menu items, and any other parameter associated with the business of being a consumer establishment serving food and/or drinks. Some of the tracked parameters might include supply pricing, menu item pricing, supplies on hand, future orders, whether they are orders by patrons for future delivery of menu items or orders by the consumer establishment for additional supplies, anticipated dates by which the supplies are no longer considered suitable for use in preparing the menu items, and the like.

Once the prices are set, the menu item prices are displayed to the patrons of the consumer establishment. The display may take any form, but is preferably an electronic display that may be updated in real-time, with current prices determined by the data analysis, by the tracking system. Thus, the patrons of the consumer establishment will always see menu item prices based on the most currently available supply and demand data for the consumer establishment. The display may also show pricing trends for the various menu items, such as whether over the last hour the price has gone up or down, and by how much. The operator of the consumer establishment has complete control and discretion over what time intervals to use when displaying trend data. In addition, the operator of the consumer establishment may choose to set different time intervals for different menu items.

The display of the menu item prices may take any form, such as at the point of service on a simple ticker board, such as the type often used to display stock market information, or on a graphic overlay on a video monitor, to a graphic sidebar on a video monitor. The latter two would allow patrons of the consumer establishment to continue watching available video programming while at the same time seeing all the current menu prices on the same monitor. Where the graphic overlay might cover part of the video programming, the sidebar would make it so the menu item pricing display does not overlap or intrude upon the video programming.

Likewise, pricing may be indicated on a mobile applications (an “app”).

In such embodiments, pricing may be available on the app for the establishment in which the user is then resident, for multiple establishments in a geographic area, for all restaurants of a certain type, such as in a certain geographic area, for all restaurants having a certain rating, such as in a geographic area, for restaurants frequented by or that are favorites of the consumer who owns the mobile device, or the like. Accordingly, the geo-location characteristics of the mobile device may indicate to the app which information is to be obtained from the central hub, and the central hub and/or the local app may indicate what information the user prefers to see. Moreover, a mobile app embodiment of the invention may allow the user to place orders from the mobile app, wherein such orders may be geo-located and/or may use identifying characteristics, such as of the user's phone, to asses to where such app-based orders are to be delivered. In this manner, the present disclosure may provide at least a three-way linkage between a point of service system, a data entry terminal device (such as may be located behind a bar or on a bar, or and at a table) that may allow for data entry, tracking, and/or ordering, by at least one of employees and consumers, and a mobile app for establishment patrons.

Thereby, with menu item pricing on display, patrons may place orders (or bids) for desired menu items at the most current prices. With this type of system, payment should be expected at the time the order is placed, or at least before the patron leaves the consumer establishment on the day the order is placed. However, any type of desirable payment plan may be established by the operator of the consumer establishment. Once an order from a patron is received, it is entered into the ordering and supply system so that the data may be collected and then transferred back into the tracking system. Patrons may be given the option of having their order delivered immediately upon preparation, or placing an order for menu items that will be delivered at some specified time in the future, such as a visit to the consumer establishment at a later date. Patrons may also be given the option of ordering as many menu items as they choose at the then current prices for delivery at a later time. The later time may be at any time the consumer establishment and patron choose to agree upon. For example, the later time may specified at the time the order is placed, or the patron may be given a record, such as a print out, or given an identifier, such as a patrons' identification card, which indicates or enables the tracking system to keep track of how many of which menu items were ordered, by which patron, and the date the order was placed. The tracking system would then keep a record of the ordered items and keep track of delivery of any of those ordered items as delivery occurs. In this manner, patrons can purchase menu items when they see the price for those menu items at or near a low, and return at a later date for delivery of those menu items, regardless of what the prices at that later date.

As referenced throughout, the above system may be implemented for more than a single consumer establishment, where the consumer establishments may be tied together in some manner, such that the data from the ordering and supply systems for each consumer establishment may be directed into a single tracking system. The single tracking system may then be used to analyze the combined data and set menu item prices for both establishments. In such a case, it may be desirable to enable the tracking system to set different menu item prices for each establishment to take into account localized trends within each establishment.

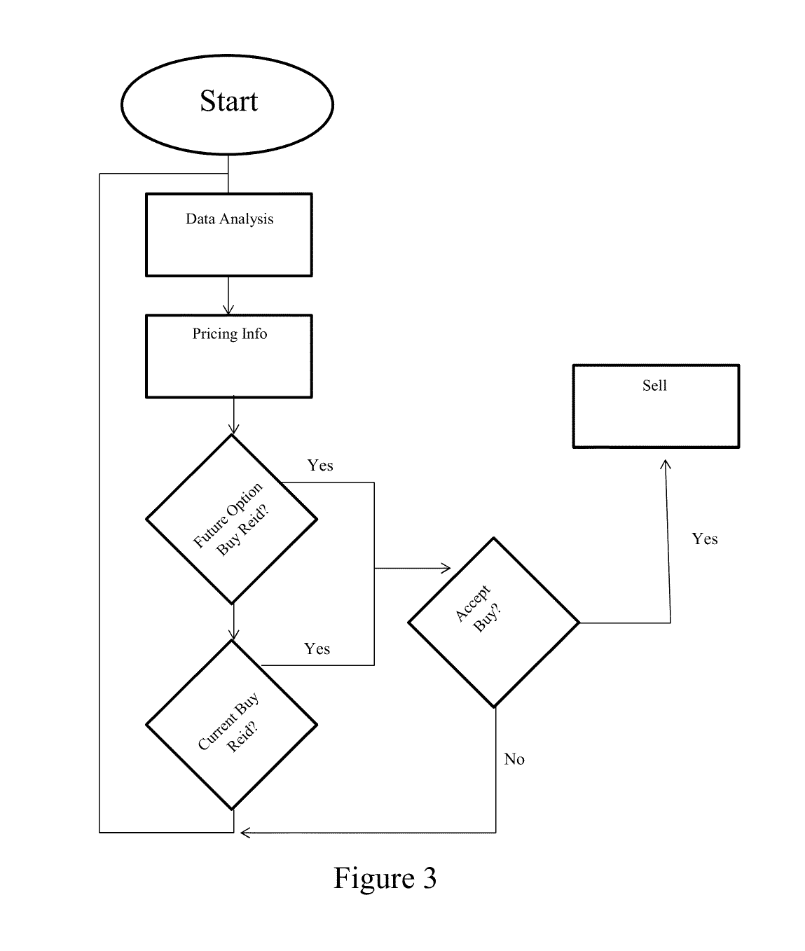

As illustrated in FIG. 3, the present disclosure additionally may allow a customer the ability to pre-buy beverages and food while in the establishment, or prior to going to an establishment. Those skilled in the pertinent art will appreciate that this establishes an options market for the aftermarket trading of customer open orders. Such options may be time and/or location-centric. For example, patrons already in an establishment at a particularly low foot-traffic time may receive especially low pricing on drinks, or may use the app to place low “option market orders” on drinks for the remainder of the evening.

An installation in accordance with the discussion herein may include, for example, an access fee for accessing the real-time pricing model (i.e., for access to the data tracking and analysis at the central hub). Further included may be a per-item transactional fee for all food and/or drink ordered through the system. Additionally, consumers may pay a fee to download the referenced app.

Thus, methods and systems for pricing menu items at a consumer establishment is disclosed. While embodiments of this invention have been shown and described, it will be apparent to those skilled in the art that many more modifications are possible without departing from the inventive concepts herein. The invention, therefore, is not to be restricted except in the spirit of the following claims.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A computing system, comprising:
a non-transitory computer readable storage medium having encoded thereon computer executable instructions for providing pricing information to a requester via a presentation layer;
a valuation engine comprised of computing code capable of executing rules that generate at least one value for at least one food item responsive to at least the supply information and customer information accessed from at least one network; and
a data layer capable of receiving at least the supply information and the customer information, and communicatively connected to said valuation engine, and further comprising food offering information for the requester for presentation to the requester via said presentation layer;
wherein the food offering information comprises at least one offer price for the at least one food item.

2. The computing system of claim 1, wherein the supply information comprises at least one consumable item.

3. The computing system of claim 1, wherein the supply information is updated in real-time.

4. The computing system of claim 1, wherein the supply information is updated in a predetermined interval of time.

5. The computing system of claim 1, wherein the presentation layer is presented on at least one video screen.

6. The computing system of claim 1, wherein the supply information comprises historical sales information related to at least one offered item.

7. The computing system of claim 1, wherein the customer information is collected in real-time.

8. The computing system of claim 1, wherein the customer information comprises consumer traffic.

9. The computing system of claim 1, wherein the at least one value for the at least one food item is bounded by predetermined price limits.
